(19) United States
(12) Patent Application Publication
(10) Pub. No.: US 2012/0026342 A1
(43) Pub. Date: Feb. 2, 2012

(54) ELECTRONIC SYSTEM COMMUNICATING WITH IMAGE SENSOR

(76) Inventors: Xiaoguang YU, Wuhan (CN); Yishao Max HUANG, Santa Clara, CA (US); Sterling DU, Palo Alto, CA (US)

(21) Appl. No.: 12/844,480

(22) Filed: Jul. 27, 2010

(51) Int. Cl. H04N 5/225

(52) U.S. Cl. 348/207.1; 348/E05.024

(57) ABSTRACT

A system includes a serial input/output (I/O) interface, a second I/O interface and a controller. The controller is coupled to an image sensor by the serial I/O interface and is coupled to a signal processor of a computer by the second I/O interface and can transfer image data input acquired by the image sensor to the signal processor. The signal processor can process the image data input.

### BACKGROUND

Webcams are image capture devices connected to a computer or a computer network. There are many popular uses for webcams, such as video telephony and recording of video files or still-images. FIG. 1 shows a conventional application 100 of a webcam. The webcam 110 includes an image sensor 112 and a signal processor such as a digital signal processor (DSP) chip 116. The image sensor 112 is coupled to the DSP chip 116 by a parallel video interface 114. The DSP chip 116 can process image data input acquired by the image sensor 112. Usually, a Universal Serial Bus (USB) is used for data transfer between the webcam 110 and a motherboard 130 of a computer. A cable 150 can transfer the processed data output by the DSP chip 116 to a USB port 132 of the motherboard 130, and the data can be further transferred to a CPU 134 on the motherboard 130.

However, both the parallel video interface 114 and the USB have a limitation on bandwidth. Therefore, the video quality requirements and the real time requirements of some applications, such as a video telephony application, cannot be met.

### SUMMARY

In one embodiment, a system includes a serial input/output (I/O) interface, a second I/O interface and a controller. The controller is coupled to an image sensor by the serial I/O interface and is coupled to a signal processor of a computer by the second I/O interface and can transfer image data input acquired by the image sensor to the signal processor. The signal processor can process the image data input.

### BRIEF DESCRIPTION OF THE DRAWINGS

Features and advantages of embodiments of the claimed subject matter will become apparent as the following detailed description proceeds, and upon reference to the drawings, wherein like numerals depict like parts, and in which:

FIG. 1 shows a conventional application of a webcam.

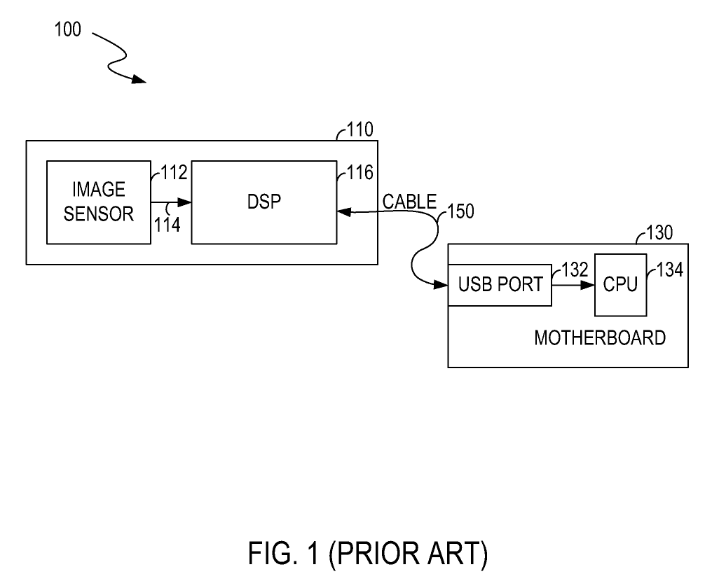

FIG. 2 shows a data transfer system according to one embodiment of the present invention.

FIG. 3 shows a data transfer system according to one embodiment of the present invention.

FIG. 4 shows a flowchart of data transfer in a data transfer system according to one embodiment of the present invention.

FIG. 5 shows a data transfer system according to another embodiment of the present invention.

FIG. 6 shows a data transfer system according to another embodiment of the present invention.

FIG. 7 shows a flowchart of method for controlling data transfer according to one embodiment of the present invention.

### DETAILED DESCRIPTION

Reference will now be made in detail to the embodiments of the present invention. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims.

Embodiments described herein may be discussed in the general context of computer-executable instructions residing on some form of computer-usable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions utilizing the terms such as “transferring” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

By way of example, and not limitation, computer-usable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, random access memory (RAM), read only memory (ROM), electrically erasable programmable ROM (EEPROM), flash memory or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information.

Communication media can embody computer-readable instructions, data structures, program modules or other data and includes any information delivery media. By way of example, and not limitation, communication media includes wired media such as a wired network or direct-wired connection, and wireless media such as acoustic, radio frequency (RF), infrared and other wireless media. Combinations of any of the above should also be included within the scope of computer-readable media.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

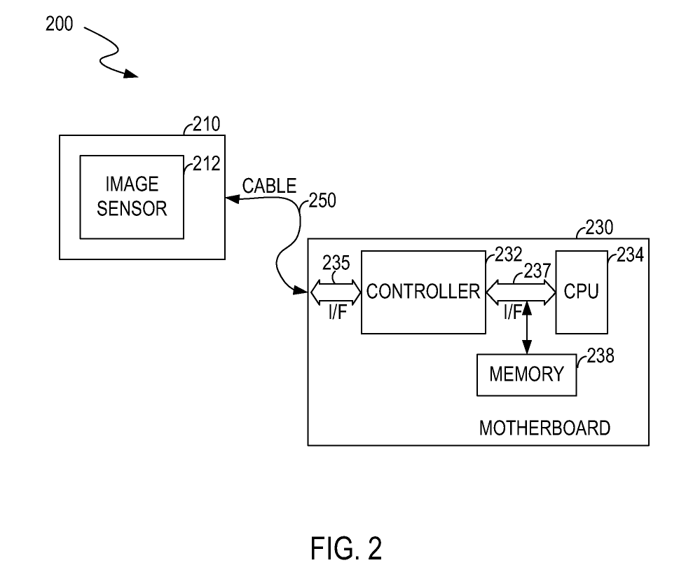

FIG. 2 shows a data transfer system 200 according to one embodiment of the present invention. In the example of FIG. 2, the data transfer system 200 includes a webcam 210, a motherboard 230 of a computer system such as a desktop computer, laptop computer, or the like, and a cable 250. The webcam 210 includes an image sensor 212. The motherboard 230 includes a controller 232, a signal processor such as a central processing unit (CPU) 234, interfaces 235 and 237 coupled to the controller 232, and a memory 238.

In one embodiment, the controller 232 is implemented as a single chip built in the motherboard 230. In another embodiment, the controller 232 is integrated in a chipset of the motherboard 230. In another embodiment, the controller 232 can be embedded in any chip on the motherboard 230.

Advantageously, the webcam 210 does not include a DSP chip to process the image data input acquired by the image sensor 212. The unprocessed image data input can be transferred to the memory 238 of the motherboard 230 via the cable 250, the interface 235, the controller 232, and the interface 237. The CPU 234 can access the data in the memory 238 and process the data for various purposes. Therefore, the webcam 210 is more stable, and video quality is better because it is not impacted by the DSP chip temperature. Furthermore, the webcam 210 can be smaller, and if the webcam 210 is built into the computer system, the computer system can also be smaller.

The image sensor 212 has a serial interface, in one embodiment. The serial interface can be, but is not limited to, a Mobile Industry Processor Interface (MIPI) or a Standard Mobile Imaging Architecture (SMIA) interface. In general, the serial interface provides higher bandwidth than USB 2.0. For example, a MIPI interface has relatively high bandwidth and provides a one gigabit/second/lane/direction of raw bandwidth. The interface 235 is an interface that is compatible with the serial interface of the image sensor 210. In other words, the interface 235 can be a MIPI interface if the image sensor 212 has a MIPI interface. Thus, data can be transferred between the webcam 210 and the controller 232 according to a relatively high data transfer rate.

In one embodiment, the interface 237 can be, but is not limited to, a peripheral component interconnect express (PCIe) interface. PCIe is a computer interconnect standard having a relatively high data transfer rate. For example, a PCIe link is able to support up to 32 lanes and provide an effective 2.5 gigabits/second/lane/direction of raw bandwidth. Thus, data can be transferred between the controller 232 and the memory 238 in the motherboard 230 according to a relatively high data transfer rate. Therefore, the video quality requirements and the real time requirements of some applications, such as a video telephony application, can be met.

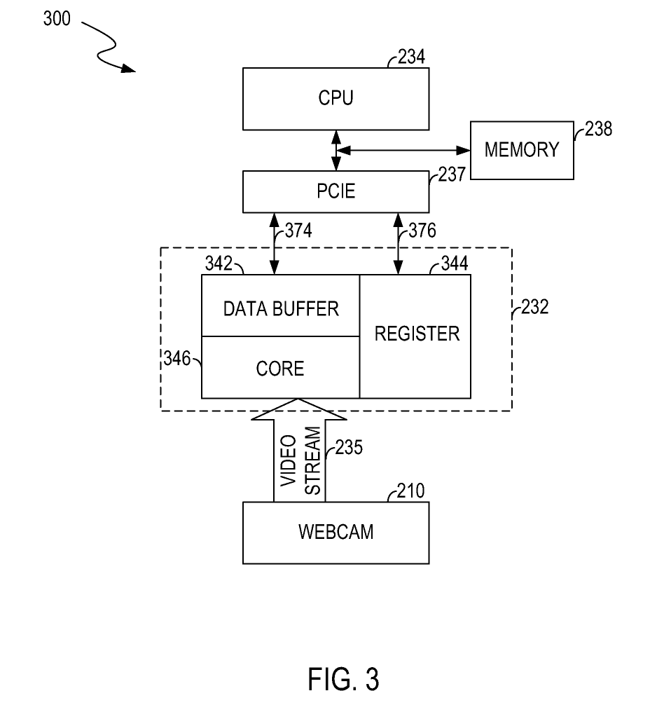

FIG. 3 shows a data transfer system 300 according to one embodiment of the present invention. Elements labeled in the same as in FIG. 2 have similar functions. In the example of FIG. 3, the data transfer system 300 includes a signal processor such as the CPU 234, interfaces such as the interface 237 and the interface 235, the controller 232, the webcam 210, and the memory 238. The controller 232, the interface 237, and the interface 235 can transfer data between the CPU 234 and the webcam 210.

The interface 237 can serve as an I/O (input/output) interconnect between the CPU 234 and the controller 232. The information transferred in the data transfer system 300 can include data information and control information. In one embodiment, the CPU 234 operates as a master to initiate a data transfer. In this instance, the CPU 234 can send the control information to the controller 232 through a control path 376. The control information can instruct the webcam 210 to start video capture to acquire the data image input. The control information can request a video stream/data image input be transferred from the webcam 210 to the CPU 234. The control information can also enable the hand-shake between the CPU 234 and the controller 232 before the video stream is transferred. The controller 232 can transfer the video stream from the webcam 210 to the memory 238 through a data path 374.

In the example of FIG. 3, the controller 232 includes a data buffer 342, a register 344, and a core 346. The register 344 can store the control information received from the interface 237. The core 346 can communicate with the webcam 210. In one embodiment, the core 346 can be a micro-controller and can generate signals (e.g., read signals) according to the read timing of the interface 235 to enable a data transfer process. The webcam 210 receives the signals generated by the core 346 and responds accordingly. For example, if the CPU 234 initiates a data transfer to read the video stream from the webcam 210, the core 346 can generate a read signal according to the control information from the CPU 234. In response, the webcam 210 transfers/provides the video stream to the core 346. The data buffer 342 is coupled to the core 346 and can buffer the video stream from the core 346 and provide the video stream to the interface 237. Thus, the video stream can be transferred from the webcam 210 to the memory 238.

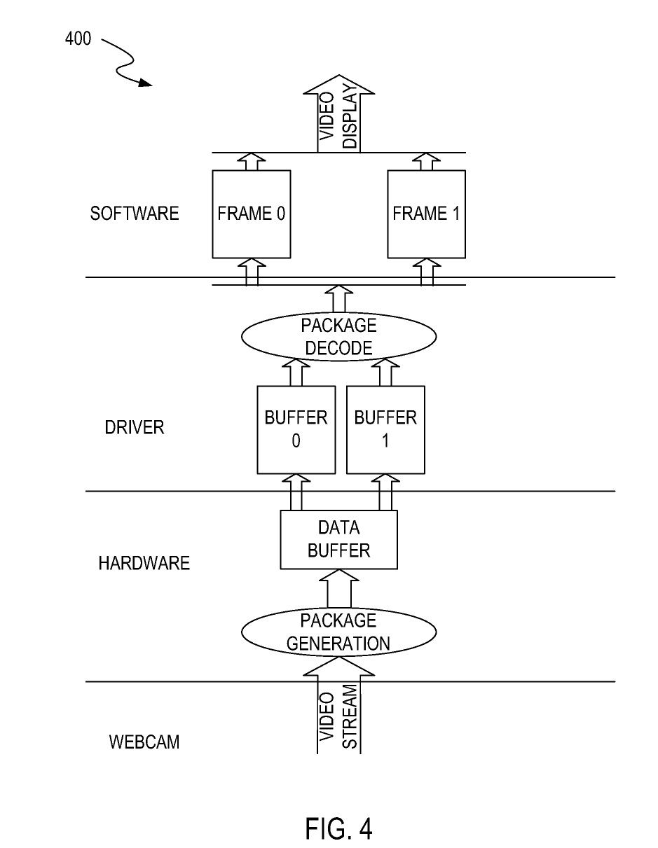

FIG. 4 shows a flowchart 400 of data transmission in a data transfer system according to one embodiment of the present invention. FIG. 4 is described in combination with FIG. 3.

In one embodiment, the CPU 234 first sends control information to the controller 232 to request a video stream from the webcam 210. In response, the webcam 210 starts video capture and provides the video stream to the core 346 of the controller 232. In one embodiment, the video stream is in the form of multiple words. The core 346 packets the video stream and generates multiple packages to the data buffer 342. The data buffer 342 can buffer the multiple packages and provide the multiple packages to buffers such as buffer 0 and buffer 1 in a driver (not shown in FIG. 3) stored in the memory 238, e.g., a computer-executed program executed by the CPU 234 to provide the video stream to software. The buffer 0 and the buffer 1 buffer the multiple packages and then these packages can be decoded by the driver to form, for example, multiple words. Then, the driver provides the multiple words to software (not shown in FIG. 3) stored in the memory 238. In one embodiment, the software is executed by the CPU 234 to display an image on a display device of the computer system. In one embodiment, the driver provides the multiple words to either frame 0 or frame 1 in the software. The driver first provides the words to one of the frames until that frame is filled, and then provides the words to the other frame. When a frame is filled, the driver informs the software to display the filled frame. Thus, the frame 0 and the frame 1 are displayed alternatively.

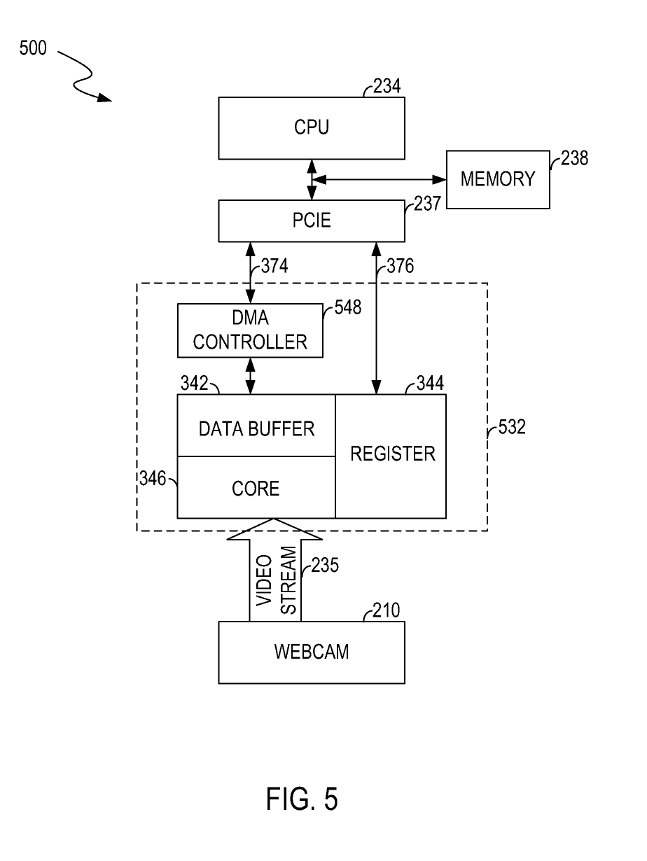

FIG. 5 shows a data transfer system 500 according to another embodiment of the present invention. Elements labeled in the same as in FIG. 3 have similar functions. In the example of FIG. 5, a controller 532 includes the data buffer 342, the register 344, the core 346, and a direct memory access (DMA) controller 548. Advantegously, the DMA controller 548 can communicate with the memory 238 to transfer the video stream provided by the data buffer 342 to the memory 238 without operation of the CPU 234. Thus, the burden on the CPU 234 can be reduced.

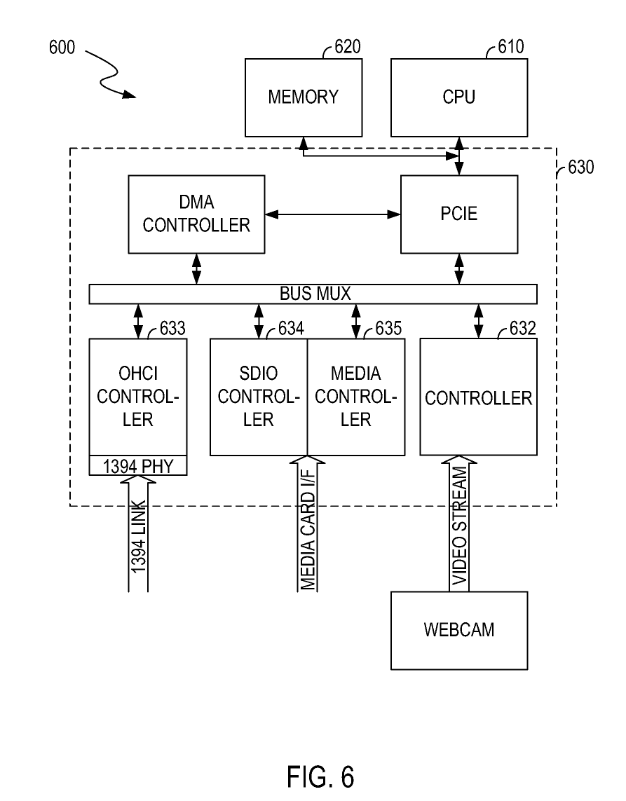

FIG. 6 shows a data transfer system 600 according to another embodiment the present invention. The controller 632 shown in FIG. 6 is similar to the controller 232 shown in FIG. 3. In the example of FIG. 6, the controller 632 is embedded in a chip 630 on the motherboard 230. In one embodiment, the chip 630 includes multiple card reader host controllers such as an open host controller interface (OHCI) controller 633, a secure digital input output (SDIO) controller 634, and a media controller 635. The OHCI controller 633 can enable data transfer between a card (not shown in FIG. 6) that complies with Institute of Electrical and Electronics Engineers (IEEE) 1394 link/interface and a host including a CPU 610 and a memory 620. The SDIO controller 634 can enable the data transfer between a security digital (SD) card (not shown in FIG. 6) coupled to the chip 630 and the host. The media controller 635 can enable the data transfer between a media card (not shown in FIG. 6) coupled to the chip 630 and the host.

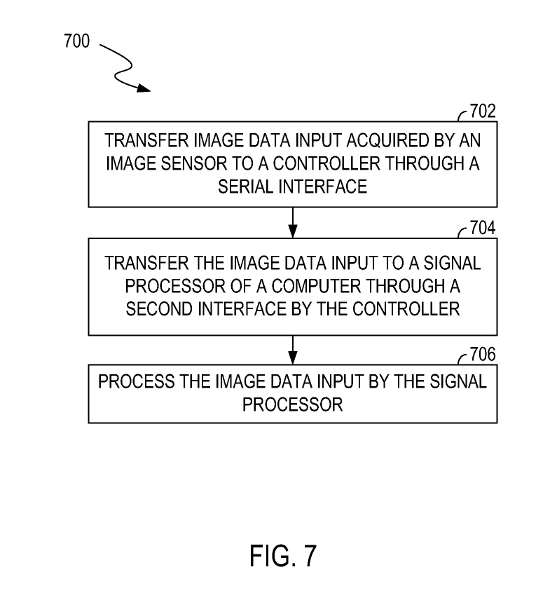

FIG. 7 shows a flowchart 700 of method for controlling data transfer according to one embodiment of the present invention. FIG. 7 is described in combination with FIG. 2. In block 702, the image data input acquired by the image sensor 212 of the webcam 210 is transferred to the controller 232 through the interface 235. The interface 235 can be, but is not limited to, a Mobile Industry Processor Interface (MIPI) or a Standard Mobile Imaging Architecture (SMIA) interface.

In block 704, the image data input is transferred to the CPU 234 through the interface 237 by the controller 232. The controller 232 can transfer the image data input to the memory 238 through the interface 237. The CPU 234 accesses the memory 238 to obtain the image data input. Thus, the image data input is transferred from the controller 232 to the CPU 234. In one embodiment, the interface 237 can be, but is not limited to, a peripheral component interconnect express (PCIe) interface.

In block 706, the CPU 234 can execute a software application to process the image data input and display the processed image data input on a display device (not shown in FIG. 2) of the computer system.

To summarize, in conventional applications, the video quality requirements and the real time requirements of some applications, such as video telephony, cannot be met due to the limitation on both the parallel video interface and the USB. In contrast, according to embodiments of the present invention, a controller with an MIPI interface and a PCIe interface, for example, can solve the aforementioned problems. Furthermore, a webcam does not include a DSP chip and the image data input acquired by the image sensor of the webcam are sent to the signal processor of the computer system for signal processing. Thus, the webcam can be smaller, and if the webcam is built in the computer system, the computer system can be smaller. Furthermore, the webcam is more stable and video quality is better because they are not impacted by the DSP chip temperature.

While the foregoing description and drawings represent embodiments of the present invention, it will be understood that various additions, modifications and substitutions may be made therein without departing from the spirit and scope of the principles of the present invention as defined in the accompanying claims. One skilled in the art will appreciate that the invention may be used with many modifications of form, structure, arrangement, proportions, materials, elements, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being indicated by the appended claims and their legal equivalents, and not limited to the foregoing description.

What is claimed is:

1. A system, comprising:
a serial input/output (I/O) interface;
a second I/O interface; and
a first controller coupled to an image sensor by said serial I/O interface and coupled to a signal processor of a computer by said second I/O interface and operable for transferring image data input acquired by said image sensor to said signal processor,
wherein said signal processor is operable for processing said image data input.

2. The system of claim 1, wherein said serial I/O interface is selected from the group consisting of a Mobile Industry Processor Interface (MIPI) and Standard Mobile Imaging Architecture (SMIA).

3. The system of claim 1, wherein said second I/O interface comprises a Peripheral Component Interconnect Express (PCIe) interface.

4. The system of claim 1, wherein said controller is embedded in a chip on a motherboard of said computer.

5. The system of claim 4, wherein said chip comprises a second controller operable for transferring data between said signal processor and a media card.

6. The system of claim 4, wherein said chip comprises a second controller operable for transferring data between said signal processor and a security digital (SD) card.

7. The system of claim 4, wherein said chip comprises a second controller operable for transferring data between said signal processor and a card complying with Institute of Electrical and Electronics Engineers (IEEE) 1394 interface.

8. The system of claim 1, wherein said controller is integrated with a chipset on a motherboard of said computer.

9. The system of claim 1, wherein said signal processor executes a software application for processing said image data input and for displaying the processed image data input on a display device of said computer.

10. A controller for controlling data transfer between a computer and an image sensor, comprising:
a register operable for storing control information sent from said computer; and
a core coupled to said image sensor by a serial input/output (I/O) interface having higher bandwidth than Universal Serial Bus (USB) 2.0, wherein said core is operable for enabling communication between said computer and said image sensor if said control information requests image data input acquired by said image sensor be transferred from said image sensor to said computer;
wherein a signal processor of said computer is operable for processing said image data input.

11. The controller of claim 10, wherein said serial I/O interface is selected from the group consisting of a Mobile Industry Processor Interface (MIPI) and Standard Mobile Imaging Architecture (SMIA).

12. The controller of claim 10, wherein said core provides said image data input to said computer through a Peripheral Component Interconnect Express (PCIe) interface.

13. The controller of claim 10, wherein said controller is embedded in a chip on a motherboard of said computer.

14. The controller of claim 13, wherein said chip comprises a second controller operable for transferring data between said signal processor and a media card.

15. The controller of claim 13, wherein said chip comprises a second controller operable for transferring data between said signal processor and a security digital (SD) card.

16. The controller of claim 13, wherein said chip comprises a second controller operable for transferring data between said signal processor and a card complying with Institute of Electrical and Electronics Engineers (IEEE) 1394 interface.

17. The controller of claim 10, wherein said controller is integrated with a chipset on a motherboard of said computer.

18. The controller of claim 10, wherein said signal processor executes a software application for processing said image data input and for displaying the processed image data input on a display device of said computer.

19. A method for controlling data transfer between a computer and an image sensor, comprising:
transferring image data input acquired by said image sensor to a controller through a serial input/output (I/O) interface having higher bandwidth than Universal Serial Bus (USB) 2.0;
transferring said image data input to a signal processor of said computer through a second I/O interface by said controller; and
processing said image data input by said signal processor.

20. The method of claim 19, wherein said second interface comprises a Peripheral Component Interconnect Express (PCIe) interface.

21. The method of claim 19, wherein said serial I/O interface is selected from the group consisting of a Mobile Industry Processor Interface (MIPI) and Standard Mobile Imaging Architecture (SMIA).
